(19) United States
(12) Patent Application Publication
(10) Pub. No.: US 2010/0291304 A1
(43) Pub. Date: Nov. 18, 2010

(54) Multifunctional Manufacturing Platform And Method Of Using The Same

(76) Inventor: Tracy Becker, Swainsboro, GA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/711,494

(22) Filed: Feb. 24, 2010

Related U.S. Application Data
(60) Provisional application No. 61/208,479, filed on Feb. 24, 2009.

(51) Int. Cl. B05D 3/12; B05C 11/00

(52) U.S. Cl. 427/355; 118/695

(57) ABSTRACT

A single, flexible, robust and low rate capable manufacturing platform that may be associated with caseless munitions firing circuits, nano and microelectromechanical (“NEMS” and “MEMS”) devices, and/or fractal antennas is described. The platform may be designed for extensive research and development in printed electronics, 3D thermo-plastics and low melt metal casting, light machining, and other processing operations necessary for the integrated fabrication of various components, such as caseless munitions components. The platform may be used in a remote location.

### CROSS REFERENCE TO RELATED APPLICATIONS

This application claims priority under 35 U.S.C. 119(e) to U.S. Patent Application No. 61/208,479, entitled Multifunctional Manufacturing Platform and Method of Using Same, with inventor Tracy Becker and filed Feb. 24, 2009.

### FIELD OF THE INVENTION

The instant invention relates to the field of manufacturing platforms, and in particular to platforms for and methods of integrating multiple functionalities in the manufacture of nano and micro scale products.

### BACKGROUND OF THE INVENTION

In the manufacture of certain products requiring nano and micro scale components, such as fractal antennas and caseless munitions firing circuits, the majority of commercial platforms available today are designed and built for a single functionality. For example, a platform including a machine or tool designed for electronic printing is not additionally suitable for three dimensional thermoplastic printing, and vice versa. This means, in the aforementioned example, that in the development of products that require both electronic printing and three dimensional thermoplastic printing, two separate machines on separate operating platforms are required. Needless to say, this requirement only increases costs and manufacturing time, while reducing quality, by necessitating that such products pass through multiple manufacturing environments, thus exposing the products to increased possibility of negative quality effects, and thus through multiple exceedingly expensive machines.

For example, each separate machine may be built by a different commercial entity, and decisions in the production and manufacturing tolerances of such separate machines is often tailored to only each entity's prime market, expertise, national affiliation, costs, and/or perceived customer need. This may lead to each machine requiring a different axis configuration, differing precision levels, and/or differing controls and user interfaces. Further, these differing controls and interfaces require different manuals, repair part inventories, and/or user training. In fact, significant increases in the training for both operators and service personnel is quite likely required due to differing controls and interfaces. It should be appreciated that in such an environment, not only do different tolerances and the like lower quality, but the opportunity for human error also significantly increases, and inevitably leads to incorrect or low quality part manufacture and equipment damage. Unacceptable results are costly in both raw materials and replacement parts, as well as in lost time.

Another problem with the multi-platform, multi-machine manufacturing environment is that any transferring of a product under production or development requires additional and valuable time, and is prone to misalignment. This would include removing the item for inspection and verification of the numerous processes in the line of assembly. To build the complex devices mentioned above, the units under production need to be removed from one machine process, inspected, and mounted in the next machine in a highly precise locating and alignment. This unquestionably increases the failure rate due to damage. Whether performed manually or robotically, transferring products, or parts thereof, can significantly increase the risk of deforming, contaminating, or otherwise damaging the product.

Further still, there is no known multifunctional platform that is ruggedized and functionally available to perform in-field, or in theater, production, in part due to the need for multiple machines to produce products such as those discussed herein. For example, in military applications, a warfighter may need to perform manufacturing steps when away from a specialized and protected laboratory facility. In such an instance, the warfighter would require duplicate platforms to finalize or perform partial manufacturing when away from the laboratory, and therefore would require a rugged multi-functional platform with the integrated tooling and interface necessary to complete the manufacture of the product while in the field.

Therefore, a need exists for a multi-axis, multi-functional, computer controlled platform that is designed for simple replication of multi-step manufactured products, and that is suitable for both laboratory and in field use.

### SUMMARY OF THE INVENTION

A single, flexible, robust and low rate capable manufacturing platform that may be associated with caseless munitions firing circuits, nano and microelectromechanical (“NEMS” and “MEMS”) devices, and/or fractal antennas is described. The platform may be designed for extensive research and development in printed electronics, 3D thermo-plastics and low melt metal casting, light machining, and other processing operations necessary for the integrated fabrication of various components, such as caseless munitions components. The platform may be used in a remote location.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 is an exemplary embodiment of a tool-changing platform, according to an aspect of the present invention; and

FIG. 2 is an exemplary embodiment of a single integrated platform suitable for performing multiple tool-based functionalities, according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical manufacturing platforms. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

The present invention relates to a multi-axis, precision positioning, computer controlled platform capable of multiple material delivery, material curing methods, and in-situ inspection capabilities, among other functionalities. The present invention may be ideal for processes, methods and manufacturing of various nanotechnology based products, and may be suitable for both research and development, at low production costs. The platform may be programmable to automatically change between print heads, material extruders, inspection devices and other equipment necessary to produce complex devices in a single setup and/or on a single platform. This single platform design minimizes item damage and loss of time due to item transfer(s). The platform may further include a common user interface and a single motion control system The platform may include “drop-on-demand” and 3D thermo plastics printing functionality, as well as robotic gripping functionality for placement and transfer of intricate parts across the platform.

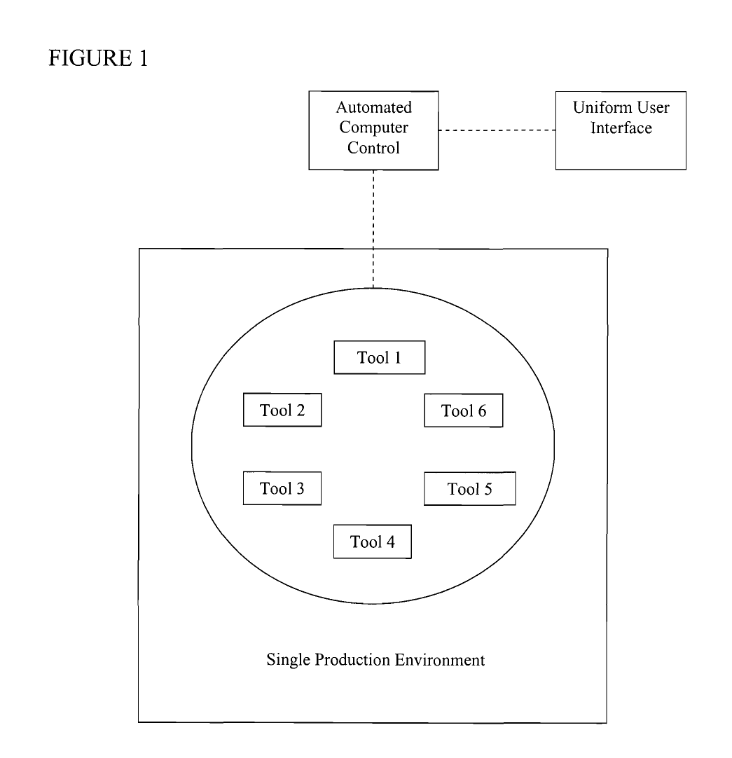

As mentioned above, the platform of the present invention may provide numerous functionalities and features. For example, the platform may provide automated ‘tool’ changing, such as multi-tool manufacturing turret that may include, for example, one or more gas inlets, outlets, vacuums, printheads, nanoprintheads, and manufacturing tools, such as sterile and/or remotely manipulable pincers, drivers, guns, injectors, and the like, as shown in FIG. 1, such as to allow for unattended operation. The platform may be roll to roll production capable.

The platform may be communications network aware for remote operation and protected accessibility from the internet. The platform may, for example, include an in-situ inspection camera for local or networked-remote monitoring, UV curing light source, heat curing system, and/or a solid and vacuum table, and/or may have internal product movement capabilities, such as in embodiments wherein the product moves within the platform, rather than the tooling moving or rotating as discussed hereinabove. The substrate table of the platform may be adjustable in a rotary motion, such as discussed above with regard to a turret, for aligning existing products, or in-process products, requiring modifications or further processing. The platform may also be different OEM head capable and include a standard programming interface. Such a standardized interface may be suitable for mechanical as well as electronic options and accessories. The plafform may utilize ID and OD articulated movement of the product substrate, including all robotic capabilities, such as for printing on missile nose type shapes.

The plafform may combine rapid prototyping and low production technologies while remaining suitable for incorporating future capabilities and features used in current and developing research. The plafform provides the user numerous additional capabilities on a common base and control interface, thereby reducing training and maintenance costs and significantly decreasing the “lab-to-field” time found currently in single and non-integrated platforms.

In particular embodiments, the present invention may be used for rapid fielding of nanotechnology and other advanced technologies. The present invention may further enhance development of materials and methods for advanced devices.

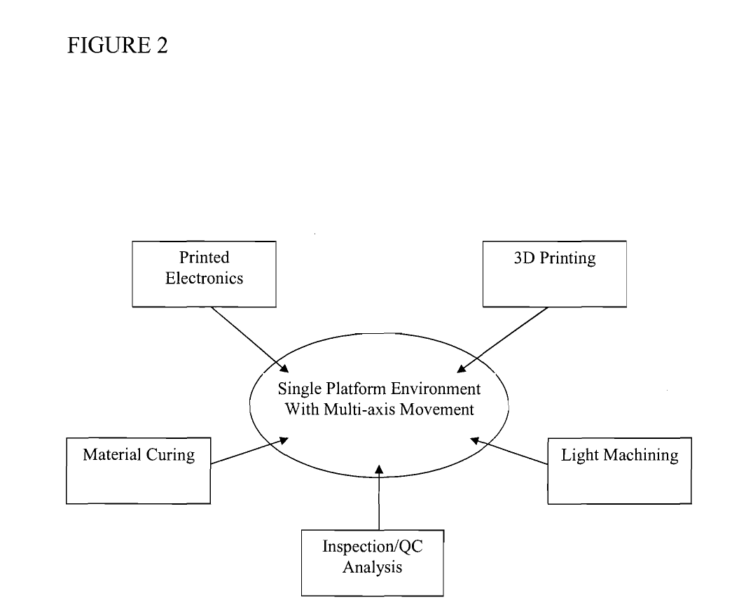

The present invention thus provides, in specific exemplary embodiments, a single, flexible, robust prototype and low rate capable manufacturing platform that may be associated with caseless munitions firing circuits, nano and microelectromechanical (“NEMS” and “MEMS”) devices, and fractal antennas, for example. As shown in FIG. 2, the platform may incorporate the tools and programming as illustrated in FIG. 1, such that it may be designed for extensive research and development in printed electronics, 3D printing in thermo-plastics and/or low melt metal casting, light machining, material curing, inspection and/or quality control analysis, and other processing operations necessary for the integrated fabrication of various components, such as caseless munitions components in a non-limiting example. The platform may be used in a remote location for rapid transition to the use.

As mentioned above, the platform of the present invention may include electronic printing functionality. Printed electronics involves accurate depositing of functionalized inks, such as nanoscale silver, gold and copper, for example, on a variety of substrates, including flexible substrates, to create electrical circuits and components. This process is cheaper and greener then conventional electronics, and provides for significant reductions in inventories.

The platform of the present invention may incorporate multiple axis movement for electronic printing, such as in a Cartesian pattern. In an exemplary embodiment, six axis may be computer controlled. It should be appreciated that the platform may inactivate or otherwise utilize fewer axis of movement, depending on the devices in manufacture and other environmental circumstances.

In one specific exemplary embodiment of the present invention, the platform may include “drop-on-demand.” electronic printing. Drop-on-demand demand printing allows users to precisely control the placement of the ink on the substrate, and with minimum effort to change the design to accommodate new concepts or ideas. Drop-on demand is comparable to computer numerical controlled (CNC) machine tools used in the metal cutting industry. By further example, the printing component may include a three axis Cartesian system under computer controlled movement commands. Additional axis may be included, both powered and/or manual, depending on any particular application. The platform of the present invention may include the integration of differing print heads, as well as six axis control of plafform movement, making the plafform suitable for multiple styles of drop-on-demand printing, such as thermal, piezoelectric, electrostatic and aerosol methodologies.

Printed electronics may be used for the production of bridgehead circuits for energetic ignition and caseless munitions intended to have NEMS or MEMS devices as a payload. Fractal antennas may also be produced by printed electronics. The fractal antennas may be production ready once testing is successful. New, improved or replacement antennas may then be easily reproducible on a duplicated plafform either in-theater or in factory production.

The plafform of the present invention may further include the aforementioned 3D printing functionality for the printing of thermoplastics and creation of full 3D models in a relatively rapid time frame. The process consists of sequential printing of layers of extruded plastics to create the model or item. This capability is critical to create complex physical models that can be used in caseless munitions in both the thruster design and NEMS/MEMS mounting.

The platform of the present invention may further include the aforementioned precision light machining functionality. Precision light machining is often required during mounting of a nano or micro-ink printed device. In certain exemplary embodiments, such precision light machining may include milling, drilling and tapping for connecting one layer of substrate to another, or for electronic component mounting of NEMS/MEMS devices. Additionally, because printed conductive inks often have irregular surfaces after curing that interfere with subsequent layer deposition in forming semiconductors, a polishing operation may be included in the precision light machining to correct the subject surface. Further, precision placement of NEMS/MEMS devices in larger construction, such as a munitions warhead, may be performed in an automated manner in any production environment. This is accomplished by robotics with precision ‘end-effectors’ or ‘fingers’ that transport the NEMS/MEMS device and properly place it, under programmed computer control, in its proper location. Because the platform provides such machining as integrated with the aforementioned functionalities, all in an automated format, the platform provides for low failure rates and low damage rates during production assembly.

The platform of the present invention may further include laser soldering functionality, or the use of lasers to heat automatically fed solder to connect NEMS/MEMS devices. This functionality provides a high precision and repeatable quality when performed in a computer controlled environment.

Because quality control is critical in an automated manufacturing environment, the platform may include video cameras, lasers and physical probing of the device during the process of manufacture. This quality control functionality helps ensure correct dimensions and shapes of the manufactured devices, and the proper placement of sub devices or components within the manufacturing process.

The platform of the present invention may further include duplication modeling functionality via the digitization of existing models for duplication, as well as the simplified modification of existing models. This process may include a physical probe or a range finding laser to map the existing item, and to convert the data to a computer model for duplication or modification.

The platform also incorporates a single human interface, which may be local or remotely networked, to control each of the integrated machine functionalities. The platform may further incorporate programmable capabilities either by manual input or by input of drawings or instructions developed by applicable design software. All drivers necessary for each integrated functionality may also be provided in formats conducive to each other and the underlying software operating systems.

According to an aspect of an exemplary embodiment of the present invention, the base of the platform may be a high precision three to six axis machine specifically designed to accommodate the functionalities described hereinthroughout. In an exemplary embodiment, precision levels may be between approximately 0.0002″ to 0.004 mm positioning resolution. The platform ‘work table’ may be rotationally adjustable to provide accurate alignment of existing material to be worked on. The platform work table may further be replaceable to be a vacuum hold down, solid or removed to be replaced with a standard robot for working on the ID of a missile nose, for example. It should be appreciated that some of the processes rely on gravity which may significantly impact platform functionality. Each functional component may be supplied with unique wiring, vacuum, air and materials, such as inks, plastics, metal, and the like. An ultraviolet curing source and video inspection/alignment camera may additionally be mounted on the platform for automatic or scheduled use, or manually, such as an on demand format, rather than as a separate functional tool.

According to another aspect of the present invention, the platform controls and video feeds may be networked, either locally or wide area, or otherwise ‘network aware’ to allow for internet/intranet access for set-up assistance, maintenance, training and other uses. Therefore the present invention may be a remote controllable platform.

In practice, the processing of the specific exemplary embodiment producing caseless munitions needing NEMS/MEMS devices as a payload, functionalities performed by the platform may include printed electronics, fabrication of the body in using plastics and/or metal, deposition of an energetic material, precision placement of the NEMS/MEMS device. Thus, the present invention provides a single integrated platform to perform the functionalities of what would otherwise require five different machines, plus inspection stations and additional repeat operations.

In another example, in the processing of fractal antennas, functionalities performed by the platform may include drop-on-demand and 3D printing may for producing the necessary printed electronics. Fractal antenna design requires a high degree of design, manufacture, precision, testing and correcting for proper production. Using standard circuit board creation mechanisms, the process has historically been time consuming, expensive, and not environmentally friendly. The present invention provides for in-line production of the substrate or packaging for the antenna, and the end product is production ready when final testing proves successful. The present invention also provides for development of new, improved or replacement antennas on a duplicate platform in-theatre or in a factory to allow for seemless reproduction or partial completion in multiple locations.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

1. A single integrated manufacturing platform, comprising:
a work table having at least six axes of movement, comprising;
a printer for printing electronics;
a three dimensional thermoplastic printer;
a plurality of precision machining tools; and
a computing device, the computing device having a single interface and software for controlling and automating ones of the electronics printer, the three dimensional thermoplastics printer, and the precision machining tools along ones of the at least six axes of movement to provide at least one component having an integrated fabrication of at least two of the printed electronics, the three dimensional thermoplastics prints, and the precision machining.

2. The single integrated manufacturing platform of claim 1, wherein the electronics comprise microscale electronics.

3. The single integrated manufacturing platform of claim 2, wherein the electronics comprise nanoscale electronics.

4. The single integrated manufacturing platform of claim 1, wherein the electronics comprise electromechanical electronics.

5. The single integrated manufacturing platform of claim 1, wherein the component comprises a caseless munition.

6. The single integrated manufacturing platform of claim 1, wherein said work table further comprises at least one low melt metal casting for controlling and automating by said computing device.

7. The single integrated manufacturing platform of claim 1, wherein the at least six axes of movement comprise at least robotic gripping.

8. The single integrated manufacturing platform of claim 1, wherein said work table comprises a multi-tool turret for the six axes of movement.

9. The single integrated manufacturing platform of claim 8, wherein said work table further comprises gas inlets and outlets.

10. The single integrated manufacturing platform of claim 1, wherein the electronics printer comprises a nanoprinthead.

11. The single integrated manufacturing platform of claim 9, wherein said gas inlets and outlets at least partially comprise a vacuum chamber.

12. The single integrated manufacturing platform of claim 1, wherein at least the precision machine tools are sterile.

13. The single integrated manufacturing platform of claim 1, wherein said work table further comprises remote visual monitoring.

14. The single integrated manufacturing plafform of claim 1, wherein said computing device is remotely networked.

15. The single integrated manufacturing platform of claim 1, wherein the at least six axes comprise rotary axes.

16. The single integrated manufacturing plafform of claim 1, wherein the electronic printer comprises a Cartesian axis pattern of the at least six axes.

17. The single integrated manufacturing plafform of claim 1, wherein the precision tools comprise a resolution in the range of 0.002 to 0.004 mm.

18. A method of integrated fabrication, comprising:
moving a substrate over three to six axes of movement, said moving comprising at least:
nanoscale printing;
thermoplastic printing; and
precision machining;
controlling said moving via at least one computing connection; and
providing an integration fabricated component from the substrate in accordance with said controlling.
